(19) United States
(12) Patent Application Publication
(10) Pub. No.: US 2024/0047789 A1
(43) Pub. Date: Feb. 8, 2024

(54) FLEXIBLE BATTERY AND ELECTRIC APPARATUS USING SUCH FLEXIBLE BATTERY

(71) Applicant: Ningde Amperex Technology Limited, Ningde (CN)

(72) Inventors: Kun YAN, Ningde (CN); Zhonghuang XU, Ningde (CN)

(73) Assignee: Ningde Amperex Technology Limited, Ningde (CN)

(21) Appl. No.: 18/465,236

(22) Filed: Sep. 12, 2023

Related U.S. Application Data
(63) Continuation of application No. PCT/CN2021/080846, filed on Mar. 15, 2021.

(51) Int. Cl. H01M 50/105; H01M 50/474; H01M 10/04; H01M 50/538; H01M 50/54

(52) U.S. Cl. CPC H01M 50/105; H01M 50/474; H01M 10/0431; H01M 50/538; H01M 50/54; H01M 10/0463

(57) ABSTRACT

A flexible battery includes a plurality of electrode assemblies, an electrical connector, elastic insulation members, and a package bag. The electrical connector is electrically connected to two adjacent electrode assemblies. The elastic insulation members are disposed at two end terminals of the electrical connector and have a gap with the electrode assemblies. The package bag is provided with a first dent accommodating the electrode assembly and the elastic insulation member, and a second dent accommodating the electrical connector. In the flexible battery, stress concentration caused by bending after packaging can be effectively reduced, so the package bag and electrical connector of the flexible battery are not prone to fracture, providing effective protection for the electrode assemblies, improving service life of the flexible battery, and ensuring stable performance and safety of the flexible battery.

### CROSS-REFERENCE TO RELATED APPLICATION

This application is a continuation of International Patent Application No. PCT/CN2021/080846, filed on Mar. 15, 2021, the disclosure of which is hereby incorporated by reference in its entirety.

### TECHNICAL FIELD

This application relates to the field of battery technologies, and in particular, to a battery having good flexibility and an electric apparatus using such battery.

### BACKGROUND

Smart wearable electronic products and other devices generally have good flexibility, able to be freely bent or even folded. Such feature is deeply loved by consumers. A battery with local flexibility, such as a spine-like battery or a flexible battery group formed through connection in parallel or series, can be bent along a packaging position between adjacent battery cells after packaging, satisfying flexibility requirements of many electronic products. Limited by the development level of battery packaging materials, currently, the flexible battery packaging material in use is generally aluminum plastic film. The packaging directly applied to the flexible battery typically has the following disadvantage: in a bending process of a package bag between adjacent cells, stress acting on a root portion is high, resulting in fatigue of the packaging material and short service life. The package bag between adjacent cells applies a certain degree of compression on edges and corners of the battery cells, causing a significant risk of short circuits.

### SUMMARY

To resolve the problem in a spine-like flexible battery or combined flexible battery packaged with a conventional aluminum plastic film that the packaging material and electrical connector at a flexible joint are prone to bending fracture so that the packaging material causes compression on the battery cell, this application proposes a flexible battery and an electric apparatus using such flexible battery. In that flexible battery, the package bag and electrical connector are not prone to fracture and do not cause compression on electrode assemblies when bent.

This application provides a flexible battery, including: a plurality of electrode assemblies, where the electrode assembly includes a cathode electrode plate, an anode electrode plate, and a separator disposed between the cathode electrode plate and the anode electrode plate; an electrical connector, where two end terminals of the electrical connector are respectively electrically connected to adjacent electrode assemblies; elastic insulation members, where the elastic insulation members are disposed at the two end terminals of the electrical connector and have a gap with the electrode assemblies; and a package bag, where the electrode assemblies, the electrical connector, and the elastic insulation members are enveloped in the package bag.

In an embodiment, the package bag is provided with a first dent accommodating the electrode assembly and the elastic insulation member. In an embodiment, the package bag is further provided with a second dent accommodating the electrical connector.

In an embodiment, a length of the second dent in an extending direction of the electrical connector (defined as a first direction) is a (which is a distance between adjacent first dents), and a thickness of the first dent in a thickness direction of the electrode assembly (defined as a second direction) is t. A ratio of a/t may be set according to a required bending angle such that adjacent electrode assemblies can bend within a defined angle, and the electrode assemblies do not compress each other in a bending process.

In an embodiment, the second dent has a depth only enough to accommodate the electrical connector, and the second dent may be heat sealed with the electrical connector by heat sealing or not hot sealed with the electrical connector.

In an embodiment, the plurality of electrode assemblies are connected in parallel by the electrical connector. In an embodiment, the plurality of electrode assemblies are connected in series by the electrical connector.

In an embodiment, the electrode assembly is formed by winding the cathode electrode plate, the separator, and the anode electrode plate. In an embodiment, the electrode assembly is formed by laminating the cathode electrode plate, the separator, and the anode electrode plate.

In an embodiment, the electrical connector is integrally formed with a cathode electrode plate or anode electrode plate of the adjacent electrode assemblies by die-cutting. In this case, the plurality of electrode assemblies can be connected in parallel by simultaneously winding or stacking the electrode assemblies, to obtain a spine-like flexible battery.

In an embodiment, the two end terminals of the electrical connector are respectively welded to electrode plates of the adjacent electrode assemblies to implement connection of the plurality of electrode assemblies in parallel or series, thereby obtaining a combined flexible battery.

In an embodiment, each electrode assembly includes a cathode tab disposed on the cathode electrode plate and an anode tab disposed on the anode electrode plate, and the electrode assemblies are connected in parallel or series by directly welding the tabs. Alternatively, according to a length requirement, tabs of the electrode assemblies can be welded with a certain length of adapter tab to implement connection of the electrode assemblies in parallel or series. In this embodiment, the tabs directly welded or adaptively welded are equivalent to the electrical connector connecting the adjacent assemblies.

In an embodiment, the gap between the elastic insulation member and the electrode assembly has a certain width in the extending direction of the electrical connector. The width of the gap can be set according to the maximum deformation of the elastic insulation member in a required usage environment. The gap reserves space for the deformation of the elastic insulation member to prevent excessive bending. In an embodiment, a width of the gap in an extending direction of the electrical connector is at least 0.5 mm.

In an embodiment, the elastic insulation members are respectively disposed on two surfaces of the electrical connector. In an embodiment, the elastic insulation members are disposed on one surface of the electrical connector. In some embodiments, the elastic insulation member can be fastened to the surface of the electrical connector by adhesive or hot melting.

In an embodiment, the elastic insulation member is strip-shaped with a cross-section in a shape including any one of rectangular, trapezoidal, elliptical, circular, triangular, or other irregular shapes.

In an embodiment, a material of the elastic insulation member includes at least one of injection molded rubber or an injection molded expanded foam material.

In an embodiment, the injection molded rubber includes at least one of silicone rubber, ethylene propylene diene monomer rubber, polybutadiene, styrene-butadiene, isoprene rubber, and fluororubber. The injection molded foam material includes at least one of EPE (pearl cotton or expanded polyethylene), EPP (expanded polypropylene), EPVC (polyvinyl chloride paste resin), EVA (ethylene-vinyl acetate copolymer), EPS (expanded polystyrene), expanded ethylene propylene diene monomer rubber, expanded styrene-butadiene, expanded neoprene, expanded silicone rubber, or expanded fluororubber.

This application further proposes an electric apparatus, and the electric apparatus includes the flexible battery described above as a power source.

In the flexible battery and the electric apparatus using such flexible battery provided in this application, stress concentration caused by bending after packaging can be effectively reduced, so the package bag and electrical connector of the flexible battery are not prone to fracture, providing effective protection for the electrode assemblies, improving service life of the flexible battery, and ensuring stable performance and safety of the flexible battery.

### BRIEF DESCRIPTION OF DRAWINGS

The following further describes this application in detail with reference to the accompanying drawings and embodiments.

FIG. 1 is a schematic diagram of a flexible battery according to an embodiment of this application;

FIG. 2 is a schematic diagram depicting a cross-sectional structure of an anode electrical connector in FIG. 1 along a direction I-I′;

FIG. 3 is a sectional view of an elastic insulation member in FIG. 1 along a direction;

FIG. 4 is a sectional view of a second dent in FIG. 1 along a direction III-III′;

FIG. 5 is a schematic diagram of a spine-like bare cell provided in example 1 of this application;

FIG. 6 is a schematic diagram of a combined flexible bare cell provided in example 2 of this application;

FIG. 7 is a sectional view of a flexible battery provided in example 2 of this application along a direction I-I′; and

FIG. 8 is a sectional view of a flexible battery provided in example 3 of this application along a direction I-I′.

### REFERENCE SIGNS OF MAIN COMPONENTS

Electrode assembly 10
Electrical connector 30
Anode electrical connector 31
Cathode electrical connector 32
Elastic insulation member 50
Package bag 70
First dent 71
Second dent 72
Cover plate 73
Gap 90

The examples of this application are further described with reference to the accompanying drawings in the following specific embodiments.

### DETAILED DESCRIPTION

Unless otherwise defined, all technical and scientific terms used in this specification have the same meanings as those usually understood by a person skilled in the art to which the embodiments of this application relate. The terms used in the specification of this application are merely intended to describe specific embodiments but not intended to constitute any limitation on the embodiments of this application.

It should be noted that all directional indications (for example, up, down, left, right, front, rear . . . ) in the embodiments of this application are only used to explain a relative position relationship, motion situation, and the like between components in a specific posture (as shown in the accompanying figures). If the specific posture changes, the directional indications also change accordingly.

In addition, the terms “first” and “second” involved in this application are merely intended for a purpose of description, and shall not be understood as an indication or implication of relative importance or implicit indication of a quantity of indicated technical features. Therefore, a feature defined by “first” or “second” may explicitly or implicitly include at least one such feature. In the description of this application, the meaning of “a plurality of” is at least two, for example, two, three, or the like, unless otherwise specifically defined.

In this application, unless otherwise specified and defined explicitly, the terms “connect” and “fasten” should be understood in their general senses. For example, they may refer to a fastened connection, a detachable connection, or an integral connection, may refer to a mechanical connection or an electrical connection, any may refer to a direct connection, an indirect connection via an intermediate medium, or an interaction between two elements, unless otherwise defined explicitly. A person of ordinary skills in the art can understand specific meanings of these terms in this application as appropriate to specific situations.

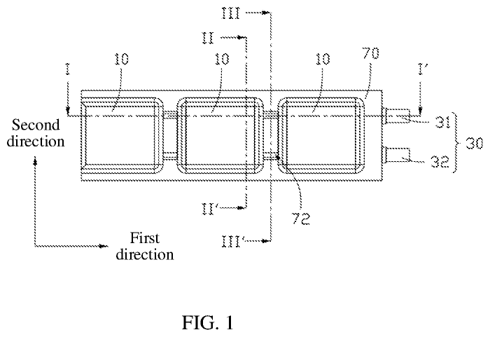

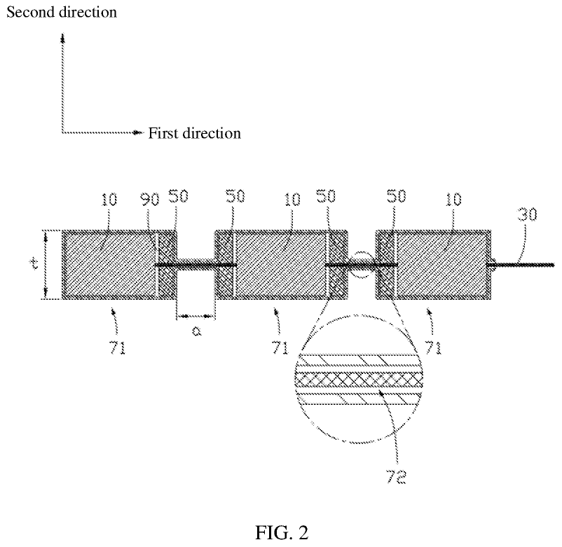

Referring to FIG. 1 and FIG. 2, this application provides a flexible battery, including a plurality of electrode assemblies 10, an electrical connector 30, elastic insulation members 50, and a package bag 70. The electrical connector 30 is electrically connected to two adjacent electrode assemblies 10. The elastic insulation members 50 are disposed at two end terminals of the electrical connector 30, and the elastic insulation members 50 have a gap 90 with the electrode assemblies 10. The package bag 70 is provided with a first dent 71 accommodating the electrode assembly 10 and the elastic insulation member 50.

As shown in FIG. 1, the battery includes three electrode assemblies 10. In some embodiments, the electrode assembly 10 includes a cathode electrode plate, an anode electrode plate, and a separator disposed between the cathode electrode plate and the anode electrode plate. The cathode electrode plate, the separator, and anode electrode plate are laminated or wound. In some embodiments, a quantity of the electrode assemblies 10 may be two or more than three. Three electrode assemblies 10 are connected in parallel by the electrical connector 30, and the electrical connector 30 includes an anode electrical connector 31 and a cathode electrical connector 32. The electrical connector 30 and the package bag 70 located between adjacent electrode assemblies 10 form a flexible joint of the flexible battery.

As shown in FIG. 2, in some embodiments, the package bag 70 is divided into two parts, an upper part and a lower part that are identical. Both the upper part and the lower part of the package bag are provided with a first dent 71, and edges of the upper part and the lower part of the package bags are heat sealed during packaging. In some embodiments, at the flexible joint, the package bag 70 may be heat sealed with the electrical connector 30, or only the package bag 70 applied elsewhere than the electrical connector 30 is heat sealed. When the electrical connector 30 is heat sealed with the package bag 70, a sealing agent is provided at a corresponding position of the package bag 70 for hot melt sealing. In some embodiments, a material of the package bag 70 is an aluminum plastic film.

As shown in FIG. 2 and FIG. 4, in some embodiments, the package bag 70 is further provided with a second dent 72 accommodating the electrical connector 30 at the flexible joint. The second dent 72 has a shallow depth and can only accommodate the electrical connector 30 (including the anode electrical connector 31 and the cathode electrical connector 32) at the flexible joint. In this embodiment, after the edge of the package bag is heat sealed, the electrical connector 30 at the flexible joint can move in the second dent, thereby improving flexibility of the battery.

Referring to FIG. 1 and FIG. 2, an extending direction of the electrical connector 30 is defined as a first direction, and a direction perpendicular to the first direction is a second direction (that is, a thickness direction of the electrode assembly). A thickness of the first dent 71 in the second direction is t, and a length of the second dent in the first direction is a (that is, a distance between adjacent first dents 71 is a). A ratio a/t is controlled based on deformation of the elastic insulation member 50 during use. A flexible bending angle of the battery can be defined such that adjacent electrode assemblies 10 can bend arbitrarily within the angle defined, and the electrode assemblies do not compress each other in a bending process.

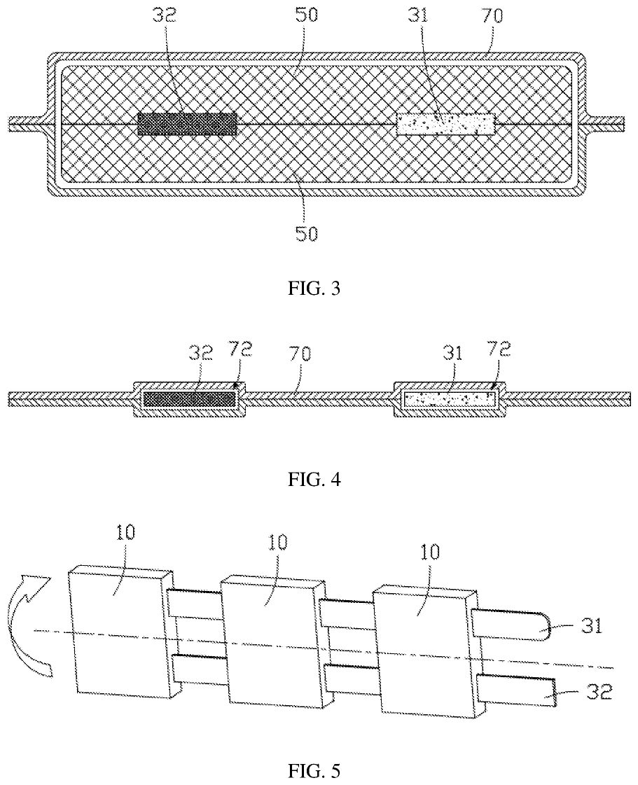

Referring to FIG. 2 and FIG. 3, the electrical connector 30 is electrically connected to adjacent electrode assemblies 10, and the elastic insulation members 50 are respectively disposed on an upper surface and a lower surface of the electrical connector 30 between adjacent electrode assemblies 10, thereby clamping the electrical connector 30 in the middle of the elastic insulation members 50. In some embodiments, the elastic insulation member 50 may be attached to surface of the electrical connector 30 by an adhesive, or a surface of the elastic insulation member may be hot melted so as to be attached to the surface of the electrical connector 30. The elastic insulation member 50 in this embodiment is strip-shaped with a cross-section in a shape selected from any one of rectangular, trapezoidal, elliptical, circular, triangular, or other irregular shapes.

In an embodiment, a gap 90 is provided between the elastic insulation member 50 and the electrode assembly 10, and a length of the gap 90 in the first direction (that is, the extending direction of the electrical connector 30) may be set according to the maximum deformation of the elastic insulation member 50 during use to prevent excessive bending. In some embodiments, the gap 90 may be set above 0.5 mm.

Further, a material of the elastic insulation member 50 includes at least one of electrolyte resistant injection molded rubber or an injection molded expanded foam material. Further, the injection molded rubber includes at least one of silicone rubber, ethylene propylene diene monomer rubber, polybutadiene, styrene-butadiene, isoprene rubber, and fluororubber. The injection molded expanded foam material includes at least one of EPE (pearl cotton or expanded polyethylene), EPP (expanded polypropylene), EPVC (polyvinyl chloride paste resin), EVA (ethylene-vinyl acetate copolymer), EPS (expanded polystyrene), expanded ethylene propylene diene monomer rubber, expanded styrene-butadiene, expanded neoprene, expanded silicone rubber, or expanded fluororubber.

The following further describes this application with reference to specific examples.

### Example 1

In this example, a bare cell packaged is a spine-like bare cell shown in FIG. 5. The cathode electrical connector 32 is integrally formed with a cathode electrode plate of the adjacent electrode assemblies 10 by die-cutting, while the anode electrical connector 31 is integrally formed with an anode electrode plate of the adjacent electrode assemblies 10 by die-cutting. The plurality of electrode assemblies 10 can be connected in parallel by simultaneously winding or stacking the electrode assemblies. A resultant flexible battery after packaging in this example is shown in FIG. 1. In this example, the battery includes three electrode assemblies 10, and adjacent electrode assemblies 10 are connected in parallel through one same set of anode electrical connector 31 and cathode electrical connector 32.

As shown in FIG. 2 and FIG. 3, in this example, paired strip-shaped elastic insulation members 50 are attached to an upper surface and a lower surface of the electrical connector 30 by an adhesive. A material of the package bag 70 is aluminum plastic film. The package bag 70 is divided into two parts, an upper part and a lower part that have identical structures. Both the upper part and the lower part of the package bag are provided with a first dent 71 and a second dent 72. The first dent 71 accommodates the electrode assembly 10 and the elastic insulation member 50 provided adjacent to the electrode assembly 10. The second dent 72 accommodates only the anode electrical connector 31 and the cathode electrical connector 32. A material of the strip-shaped elastic insulation member 50 is 246 type electrolyte resistant fluororubber material, and the adhesive is XL-313AB. The elastic insulation member 50 has a gap 90 with the electrode assembly 10. A length of the gap in the first direction is 0.5 mm, and the gap 90 can prevent excessive bending.

As shown in FIG. 4, in this example, edges of the aluminum plastic film at the flexible joint are heat sealed, so that when the flexible joint is bent, the anode electrical connector 31 and the cathode electrical connector 32 can move in the second dent of the aluminum plastic film.

In this example, a thickness t of the first dent 71 in the second direction is 2 mm, and a length a of the second dent 72 in the first direction is π mm. In this case, a bending radius is 1 mm. In this way, the flexible battery can be folded 180° in half. The elastic insulation member 50 can effectively absorb bending stress, reducing stress concentration at the root of the aluminum plastic film packaging at the flexible joint, and effectively preventing the electrode assemblies from being compressed by the aluminum plastic film in a bending and stretching process of the aluminum plastic film.

### Example 2

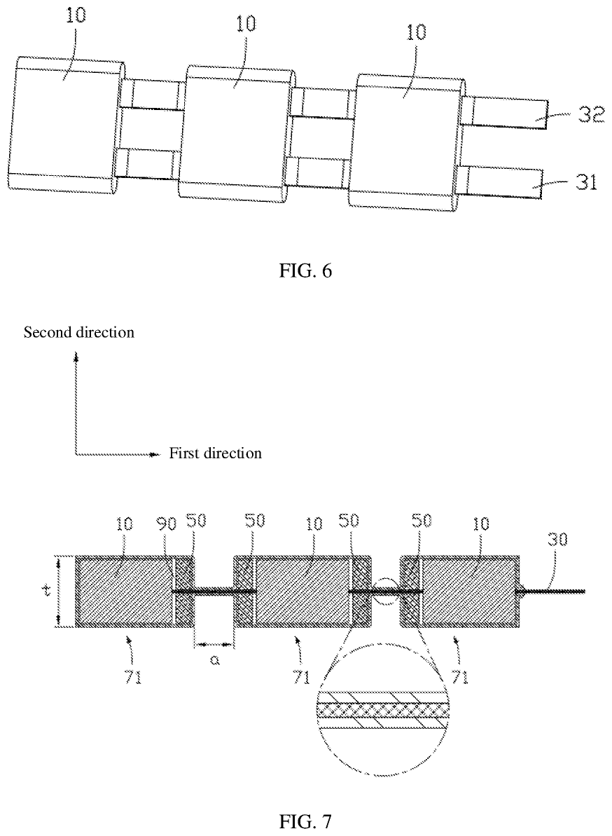

A difference from Example 1 is that in this example, the bare cell packaged is a combined flexible bare cell as shown in FIG. 6. The combined flexible bare cell is composed of a plurality of electrode assemblies 10 connected in parallel, with each electrode assembly having a separate anode tab and a separate cathode tab. Tabs of the electrode assemblies 10 are connected by direct welding or adaptive welding to implement the connection of the electrode assemblies 10 in parallel. In this way, the anode tab between adjacent electrode assemblies is equivalent to the anode electrical connector 31, and the cathode tab between the adjacent electrode assemblies is equivalent to the cathode electrical connector 32 between the adjacent electrode assemblies.

In this example, a material of the elastic insulation member 50 is silicone rubber with an elliptical cross-section. The elastic insulation member 50 is attached to the upper surface and the lower surface of the anode electrical connector 31 and the cathode electrical connector 32 by HY-308 adhesive. The elastic insulation member 50 has a gap with the electrode assembly 10, and a length of the gap in the first direction is 0.8 mm.

A difference from Example 1 is that in this example, as shown in FIG. 7, the package bag 70 is not provided with a second dent 72 at the flexible joint. The material of the package bag 70 is aluminum plastic film, and the anode electrical connector 31 and the cathode electrical connector 32 each contain a section of sealing agent at the flexible joint (not shown in the figure) at corresponding positions. When heat sealing is implemented, edges of the aluminum plastic film at the flexible joint can be completely sealed, and the electrical connector 30 and the aluminum plastic film are also hot sealed by a sealing agent. A shape of the packaged flexible battery is shown in FIG. 1.

In this example, as shown in FIG. 7, the thickness t of the first dent 71 in the second direction is 3 mm, and the distance a between the adjacent first dents 71 in the first direction is 1.5 mm. In this way, the flexible battery can be bent 90°, and within the range of 90°, the battery has high flexibility and safety.

### Example 3

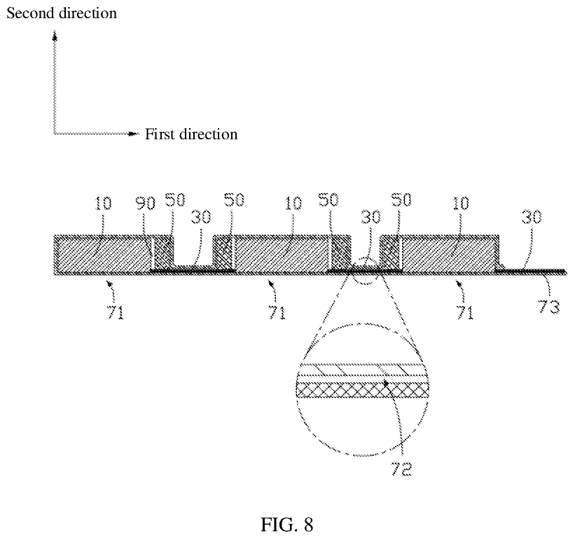

A difference from Example 1 is that as shown in FIG. 8, the package bag 70 is divided into two parts, an upper part and a lower part that have different structures. The upper part of the package bag is provided with the first dent 71 and the second dent 72, while the lower part of the package bag is a cover plate 73. During packaging, an edge of the upper part of the package bag is heat sealed with the cover plate 73. It can be understood that the upper part of the package bag may be provided with only the first dent 71, and the edge of the aluminum plastic film at the flexible joint is completely heat sealed, and the electrical connector 30 is also heat sealed with the aluminum plastic film by a sealing agent.

In this example, the material of the elastic insulation member 50 is silicone rubber with a strip-shaped cross-section. The elastic insulation member 50 is attached to one surface of the electrical connector 30 by HY-308 adhesive. As shown in FIG. 8, the elastic insulation member 50 has a gap with the electrode assembly 10, and a length of the gap in the first direction is 0.8 mm. The first dent 71 of the package bag accommodates the electrode assembly 10 and the elastic insulation member 50 disposed adjacent to the electrode assembly 10, while the second dent 72 of the package bag only accommodates the electrical connector 30.

In the flexible battery and the apparatus using such flexible battery provided in this application, stress concentration caused by bending after packaging can be effectively reduced, so the package bag and electrical connector of the flexible battery are not prone to fracture, providing effective protection for the electrode assemblies, improving service life of the flexible battery, and ensuring stable performance and safety of the flexible battery.

What is claimed is:

1. A flexible battery, comprising:
a plurality of electrode assemblies, wherein each electrode assembly comprises a cathode electrode plate, an anode electrode plate, and a separator disposed between the cathode electrode plate and the anode electrode plate;
an electrical connector, wherein two end terminals of the electrical connector are respectively electrically connected to adjacent electrode assemblies;
elastic insulation members, wherein the elastic insulation members are disposed at the two end terminals of the electrical connector, and a gap is provided between the elastic insulation members and the adjacent electrode assemblies; and
a package bag, wherein the plurality of electrode assemblies, the electrical connector, and the elastic insulation members are disposed in the package bag.

2. The flexible battery according to claim 1, wherein the package bag is provided with a first dent accommodating the plurality of electrode assemblies and the elastic insulation members.

3. The flexible battery according to claim 1, wherein the package bag is provided with a second dent accommodating the electrical connector.

4. The flexible battery according to claim 1, wherein the plurality of electrode assemblies are connected in parallel or series by using the electrical connector.

5. The flexible battery according to claim 1, wherein the electrode assembly is a wound structure or a laminated structure.

6. The flexible battery according to claim 1, wherein the electrical connector is integrally formed with a cathode electrode plate or an anode electrode plate of the adjacent electrode assemblies by die-cutting.

7. The flexible battery according to claim 1, wherein a width of the gap in an extending direction of the electrical connector is at least 0.5 mm.

8. The flexible battery according to claim 1, wherein the elastic insulation members are disposed in pairs on two surfaces of the electrical connector.

9. The flexible battery according to claim 1, wherein the elastic insulation members are disposed on one surface of the electrical connector.

10. An electric apparatus, wherein the electric apparatus comprises the flexible battery according to claim 1 as a power source.

11. The electric apparatus according to claim 10, wherein the package bag is provided with a first dent accommodating the plurality of electrode assemblies and the elastic insulation members.

12. The electric apparatus according to claim 10, wherein the plurality of electrode assemblies are connected in parallel or series by using the electrical connector.

13. The electric apparatus according to claim 10, wherein the plurality of electrode assemblies are connected in parallel or series by using the electrical connector.

14. The electric apparatus according to claim 10, wherein the electrode assembly is a wound structure or a laminated structure.

15. The electric apparatus according to claim 10, wherein the electrical connector is integrally formed with a cathode electrode plate or an anode electrode plate of the adjacent electrode assemblies by die-cutting.

16. The electric apparatus according to claim 10, wherein a width of the gap in an extending direction of the electrical connector is at least 0.5 mm.

17. The electric apparatus according to claim 10, wherein the elastic insulation members are disposed in pairs on two surfaces of the electrical connector.

18. The electric apparatus according to claim 10, wherein the elastic insulation members are disposed on one surface of the electrical connector.
